(19) United States
(12) Patent Application Publication
(10) Pub. No.: US 2009/0215422 A1
(43) Pub. Date: Aug. 27, 2009

(54) RECEIVER

(75) Inventors: Takeshi Ikeda, Tokyo (JP); Hiroshi Miyagi, Yokohama-shi (JP)

Correspondence Address: CONNOLLY BOVE LODGE & HUTZ LLP, 1875 EYE STREET, N.W., SUITE 1100, WASHINGTON, DC, 20006, US

(73) Assignee: NSC CO., LTD., Tokyo (JP)

(21) Appl. No.: 12/393,214

(22) Filed: Feb. 26, 2009

(30) Foreign Application Priority Data
Feb. 26, 2008 (JP) JP2008-044007

(51) Int. Cl. H04B 1/16

(52) U.S. Cl. 455/313

(57) ABSTRACT

By providing switch portions (8a) and (8b) for switching I and Q signals and outputting them to a single A/D converter (9), and sequentially converting the I and Q signals output from the switch portions (8a) and (8b) into digital signals by the A/D converter (9) and supplying them to a DSP (10), it is possible to carry out an A/D conversion processing for the I and Q signals through the same A/D converter (9). Consequently, it is possible to eliminate a drawback that an amplitude error or a phase error is made between the I and Q signals due to a variation in an A/D converting characteristic.

### BACKGROUND OF THE INVENTION

1. Field of the Invention

The present invention relates to a receiver, and more particularly to a receiver having a function for distributing a radio frequency received signal into an in-phase component and a quadrature component to carry out a frequency conversion.

2. Description of the Related Art

In order to transmit information as a wireless electric wave signal, generally, a so-called modulation processing for converting a baseband signal (a low frequency signal containing a DC vicinity component) into a radio frequency signal is indispensable. In a receiver for receiving, as an electric wave, the radio frequency signal generated through the modulation processing, a radio frequency signal received by a receiving antenna and a local oscillating signal output from a local oscillator are frequency-mixed by a mixer to carry out a conversion into a suitable frequency for a detection (demodulation) processing.

A modulating method of converting a baseband signal into a radio frequency signal includes a quadrature modulation (an IQ modulation) for distributing the baseband signal into an I channel (an in-phase component) and a Q channel (a quadrature component) to carry out a modulation. In a receiver for receiving, as an electric wave, a radio frequency signal generated through the IQ modulation, the received radio frequency signal is distributed into the in-phase component and the quadrature component to carry out a frequency conversion by two mixers and a signal having the in-phase component (which will be hereinafter referred to as an I signal) and a signal having the quadrature component (which will be hereinafter referred to as a Q signal) which are obtained are used to carry out a demodulation processing (for example, see Patent Document 1).

Patent Document 1: U.S. Pat. No. 7,272,375 Specification

FIG. 5 is a diagram showing an example of a conventional structure of a receiver for receiving a radio frequency signal modulated by a quadrature modulating method. As shown in FIG. 5, a conventional receiver includes a receiving antenna 101, an LNA (Low Noise Amplifier) 102, a band-pass filter (BPF) 103, mixers 104I and 104Q, a local oscillator 105, a 90° phase shifter 106, low-pass filters (LPFs) 107I and 107Q, VGAs (Variable Gain Amplifiers) 108I and 108Q, A/D converters 109I and 109Q, and a DSP (Digital Signal Processor) 110.

The LNA 102 amplifies a radio frequency signal received through the receiving antenna 101 and supplies the amplified signal to the BPF 103. The BPF 103 filters the radio frequency signal output from the LNA 102 into a predetermined band and extracts a signal in a predetermined frequency band containing a desirable receiving frequency, and outputs the extracted signal to the two mixers 104I and 104Q. The local oscillator 105 generates and outputs a local oscillating signal having a predetermined frequency. The 90° phase shifter 106 shifts, by 90°, a phase of the local oscillating signal output from the local oscillator 105 and outputs the signal thus obtained.

The first mixer 104I frequency-mixes the radio frequency signal output from the BPF 103 and an in-phase local oscillating signal output from the local oscillator 105, thereby converting the radio frequency signal into an intermediate frequency signal. The intermediate frequency signal output from the first mixer 104I is an I signal having an in-phase component in which a phase is not shifted from a received signal.

The second mixer 104Q frequency-mixes the radio frequency signal output from the BPF 103 and a quadrature local oscillating signal (having a phase shifted by 90°) output from the 90° phase shifter 106, thereby converting the radio frequency signal into an intermediate frequency signal. The intermediate frequency signal output from the second mixer 104Q is a Q signal having a quadrature component in which a phase is shifted from the received signal by 90°.

The LPFs 107I and 107Q filter the I and Q signals output from the mixers 104I and 104Q, thereby removing harmonics. The VGAs 108I and 108Q amplify the I and Q signals from which the harmonics are removed by the LPFs 107I and 107Q. The A/D converters 109I and 109Q convert, into digital signals, the I and Q signals amplified by the VGAs 108I and 108Q and output digital I and Q signals. The DSP 110 carries out a demodulation processing through a digital signal processing by using the digital I and Q signals output from the A/D converters 109I and 109Q and outputs a demodulating signal.

In the case in which the radio frequency signal is converted into the intermediate frequency signal by the mixers 104I and 104Q, an image component which is not originally required is generated in a frequency channel (a spurious point) having a certain frequency relationship with a desirable receiving frequency. Conventionally, there has been proposed a technique for removing the image component through the digital signal processing of the DSP 110 or the like. In order to effectively fulfill an image removing function through the digital signal processing, it is desirable that amplitudes of the I and Q signals generated by the mixers 104I and 104Q, A/D converted and input to the DSP 110 should be accurately coincident with each other and phases of the I and Q signals should be precisely shifted by 90°.

### DISCLOSURE OF THE INVENTION

In some cases, however, a phase error is made (a phase difference is not accurately 90°) between the I and Q signals input to the DSP 110 due to a variation in an analog element in an analog circuit including the BPF 103, or the like. In these cases, there is a problem in that the image component cannot be removed sufficiently.

Moreover, a variation occurs in a converting characteristic by an influence of a variation in manufacture, a thermal noise or the like between the first A/D converter 109I for converting the I signal into the digital signal and the second A/D converter 109Q for converting the Q signal into the digital signal. Due to the variation in the converting characteristic, similarly, an amplitude error is made between the I and Q signals input to the DSP 110 or the phase difference is not accurately 90°.

Furthermore, a variation is also made in characteristics by the influence of the variation in manufacture or the like between the first LPF 107I for carrying out a band limitation to the I signal and the second LPF 107Q for carrying out a band limitation to the Q signal and between the first VGA 108I for carrying out an amplification of the I signal and the second VGA 108Q for carrying out an amplification of the Q signal. Due to the variation in the characteristics, similarly, the amplitude error is made between the I and Q signals input to the DSP 110 or the phase difference is not accurately 90°.

In order to solve the problems, it is an object of the present invention to prevent an amplitude error or a phase error from being made between I and Q signals as greatly as possible, thereby enabling an effective removal of an image component.

In order to attain the object, in the present invention, a polyphase filter is provided in a previous stage of a mixer to remove a harmonic component by the polyphase filter. Moreover, a switching portion for switching analog in-phase and quadrature signals and outputting them to an A/D converter is provided to sequentially convert the in-phase and quadrature signals output from the switching portion into digital signals through the A/D converter and to then supply the digital signals to a digital signal processing portion. Furthermore, slight amplitude and phase errors made between the in-phase and quadrature signals due to the switching in the switching portion are corrected by the digital signal processing portion.

According to the present invention having the structure described above, it is possible to enhance a quadrature property of the in-phase and quadrature signals by using the polyphase filter. Therefore, it is possible to prevent the phase error between the in-phase and quadrature signals from being caused by a variation in an analog element or the like. Moreover, the A/D conversion processing of the in-phase and quadrature signals can be carried out by the same A/D converter. Therefore, it is possible to eliminate a drawback that the amplitude error or the phase error is made between the in-phase and quadrature signals due to a variation in an A/D converting characteristic. In addition, the slight amplitude and phase errors made between the in-phase and quadrature signals due to the switching in the switching portion can also be corrected by the digital signal processing portion. Consequently, it is possible to prevent the amplitude error or the phase error from being made between the in-phase and quadrature signals as greatly as possible, thereby suppressing an image component effectively.

### BRIEF DESCRIPTION OF THE DRAWINGS

FIG. 1 is a diagram showing an example of a structure of a receiver according to a first embodiment,

FIG. 2 is a diagram showing an example of a structure of a PPF according to the present embodiment,

FIG. 3 is a diagram showing an example of a structure of a receiver according to a second embodiment,

FIG. 4 is a diagram showing an example of a structure of a receiver according to a third embodiment, and

FIG. 5 is a diagram showing an example of a structure of a conventional receiver.

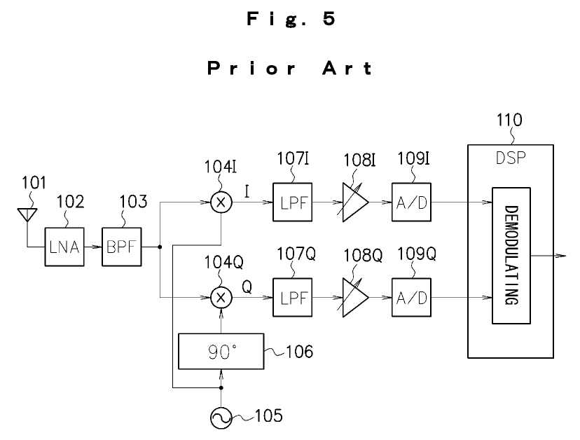

### DETAILED DESCRIPTION OF THE PREFERRED EMBODIMENTS

### First Embodiment

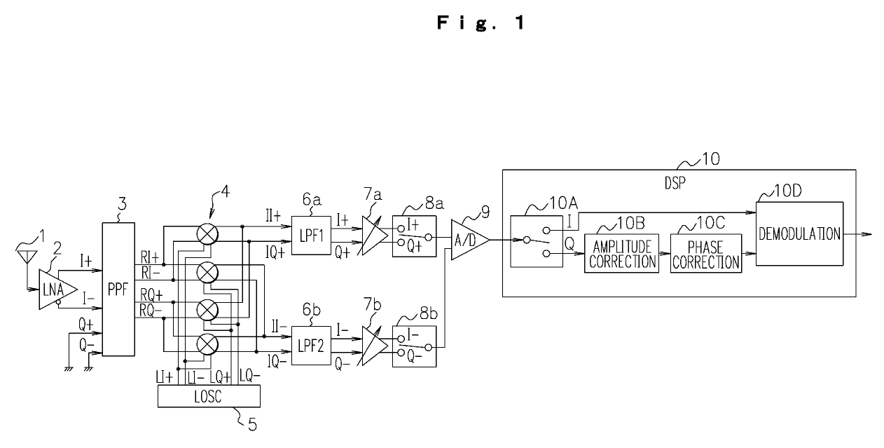

An embodiment according to the present invention will be described below with reference to the drawings. FIG. 1 is a diagram showing an example of a structure of a receiver according to a first embodiment. As shown in FIG. 1, the receiver according to the first embodiment includes a receiving antenna 1, an LNA 2, a polyphase filter (PPF) 3, a mixer 4, a local oscillator 5, LPFs 6a and 6b, VGAs 7a and 7b, previous stage switch portions 8a and 8b, an A/D converter 9 and a DSP 10. In FIG. 1, structures other than the receiving antenna 1 are integrated into a single chip through a CMOS (Complementary Metal Oxide Semiconductor) process, for example.

The LNA 2 amplifies a radio frequency signal received by the receiving antenna 1 and supplies the amplified signal to the PPF 3. The PPF 3 inputs the radio frequency signal output from the LNA 2 and outputs, to the mixer 4, four-phase radio frequency signals RI+, RI−, RQ+ and RQ− having phases shifted from each other by 90°. I denotes an in-phase signal and Q denotes a quadrature signal. Moreover, + denotes a positive phase and − denotes a negative phase. More specifically, when a phase of I+ is set to be a reference of 0°, Q+ has a phase of 90°, I− has a phase of 180°, and Q− has a phase of 270°.

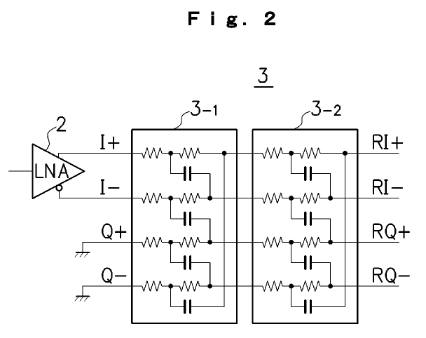

The PPF 3 is constituted as shown in FIG. 2, for example. As shown in FIG. 2, the PPF 3 has filter circuits 3₋₁ and 3₋₂ in which resistors and capacitors are connected in parallel, and has a structure in which the filter circuits 3₋₁ and 3₋₂ are cascade connected. The filter circuits 3₋₁ and 3₋₂ rotate phases every 45° in a connecting direction. As described above, if the four-phase radio frequency signals RI+, RI−, RQ+ and RQ− are represented over a complex plane, a notch is generated in a positive frequency domain of the PPF 3 because the phase is rotated clockwise from 0° to 270°. By setting a CR product of the filter circuits 3₋₁ and 3₋₂ in order to generate a notch in a frequency band having a harmonic component, it is possible to produce a desirable harmonic component suppressing effect.

The CR product represents a time constant, and strictly, an angular frequency is 1/(CR) and a frequency is 1/(2πCR). Since the PPF 3 has a symmetrical structure, an unbalanced component contained in an input signal is removed at a frequency which is almost coincident with a polar frequency of f=1/(2πCR) By the action, it is possible to enhance a quadrature property of a four-phase signal (the phases of the four-phase signal are accurately different from each other by 90°).

The local oscillator 5 includes a phase device to generate and output a local oscillating signal having a local frequency with an offset of a predetermined frequency with respect to a receiving frequency. The local oscillating signal thus generated includes four-phase local oscillating signals LI+, LI−, LQ+ and LQ− in which phases are different from each other by 90°.

The mixer 4 includes four mixer circuits, and frequency-converts the four-phase radio frequency signals RI+, RI−, RQ+ and RQ− output from the PPF 3 with the four-phase local oscillating signals LI+, LI−, LQ+ and LQ− output from the local oscillator 5 and generates four-phase intermediate frequency signals II+, II−, IQ+ and IQ− from the four-phase radio frequency signals.

In the intermediate frequency signals II+, II−, IQ+ and IQ− generated through the frequency conversion in the mixer 4, the intermediate frequency signals II+ and IQ+ having positive phases are subjected to an analog signal processing by a first signal processing system constituted by the first LPF 6a and the first VGA 7a. The first LPF 6a filters the intermediate frequency signals II+ and IQ+ having the positive phases which are output from the mixer 4, and removes harmonics. The first VGA 7a corresponds to “a first amplifier” according to the present invention and amplifies the intermediate frequency signals II+ and IQ+ having the positive phases which are output from the first LPF 6a. A structure of the first signal processing system is not restricted thereto. For example, the first LPF 6a may be a BPF. Moreover, the first VGA 7a may be omitted.

On the other hand, in the intermediate frequency signals II+, II−, IQ+ and IQ− generated through the frequency conversion in the mixer 4, the intermediate frequency signals II− and IQ− having negative phases are subjected to the analog signal processing by a second signal processing system constituted by the second LPF 6b and the second VGA 7b. The second LPF 6b filters the intermediate frequency signals II− and IQ− having the negative phases which are output from the mixer 4, and removes harmonics. The second VGA 7b corresponds to “a second amplifier” according to the present invention and amplifies the intermediate frequency signals II− and IQ− having the negative phases which are output from the second LPF 6b. A structure of the second signal processing system is not restricted thereto. For example, the second LPF 6b may be a BPF. Moreover, the second VGA 7b may be omitted.

The first previous stage switch portion 8a corresponds to “a first switch” according to the present invention, and switches an in-phase signal I+ having a positive phase and a quadrature signal Q+ having a positive phase which are included in the intermediate frequency signals having the positive phases and outputs them to the A/D converter 9. The second previous stage switch portion 8b corresponds to “a second switch” according to the present invention, and switches an in-phase signal I− having a negative phase and a quadrature signal Q− having a negative phase which are included in the intermediate frequency signals having the negative phases and outputs them to the A/D converter 9.

When the first previous stage switch portion 8a selects the in-phase signal I+ having the positive phase, the second previous stage switch portion 8b selects the in-phase signal I− having the negative phase. Consequently, positive and negative in-phase signals (hereinafter referred to as I signals) are input to the A/D converter 9. On the other hand, when the first previous stage switch portion 8a selects the quadrature signal Q+ having the positive phase, the second previous stage switch portion 8b selects the quadrature signal Q− having the negative phase. Consequently, positive and negative quadrature signals (hereinafter referred to as Q signals) are input to the A/D converter 9.

The A/D converter 9 sequentially converts, into digital signals, the I and Q signals switched alternately and output from the previous stage switch portions 8a and 8b. The DSP 10 corresponds to a digital signal processing portion according to the present invention, and sequentially inputs the I and Q signals output as digital signals from the A/D converter 9 and carries out a digital signal processing over the I and Q signals. The DSP 10 includes a subsequent stage switch portion 10A, an amplitude correcting portion 10B, a phase correcting portion 10C and a demodulating portion 10D as functional structures implemented by the digital signal processing.

The subsequent stage switch portion 10A sequentially inputs the digital I and Q signals output alternately from the A/D converter 9 and alternately distributes and outputs the I and Q signals thus input. It is preferable that the previous stage switch portions 8a and 8b and the subsequent stage switch portion 10A should be designed to carry out switching at a higher speed than an A/D converting speed of the A/D converter 9. For example, in the case in which a sampling frequency of the A/D converter 9 is represented by Fs, the previous stage switch portions 8a and 8b and the subsequent stage switch portion 10A are switched in a cycle having a double frequency 2 Fs. For example, 2 Fs=15.36 MHz is set.

In the present embodiment, thus, the A/D conversion processing for the I signal and the A/D conversion processing for the Q signal are carried out by the single A/D converter 9. Therefore, it is possible to eliminate a drawback that an amplitude error or a phase error is made between I and Q signals output from two A/D converters for the I and Q signals due to a variation in an A/D converting characteristic in the case in which the A/D converters are provided.

The amplitude correcting portion 10B corrects an amplitude of a digital Q signal distributed by the subsequent stage switch portion 10A. The amplitude is corrected by increasing or decreasing a value indicative of the amplitude of the digital Q signal, for example. The phase correcting portion 10C corrects a phase of the digital Q signal distributed by the subsequent stage switch portion 10A. The phase is corrected by regulating a quantity of delay of the digital Q signal, for example.

The phase correcting portion 10C is constituted by an FIR Finite Impulse Response) filter having a plurality of output taps, for example. The FIR filter has plural sets of filter factors and can be applied by switching them. The plural sets of filter factors offer phase correction quantities which are different from each other. By selecting any of the sets to apply the filter factors, accordingly, it is possible to cause the phase correction quantity to be variable.

As described above, according to the present embodiment, it is possible to prevent the amplitude error and the phase error from being caused by the variation in the A/D converting characteristic. However, a predetermined switching time is required in the previous stage switch portions 8a and 8b and the subsequent stage switch portion 10A. Due to the switching, therefore, slight amplitude and phase errors are made between the I and Q signals output from the subsequent stage switch portion 10A.

By increasing a switching speed, it is possible to reduce the amplitude and phase errors caused by the switching more sufficiently than the amplitude and phase errors caused by the variation in the A/D converting characteristic. Even if the amplitude and phase errors caused by the switching are exactly permitted, accordingly, a quantity of the errors is reduced considerably as compared with the conventional structure using two A/D converters.

However, it is preferable to prevent the amplitude and phase errors from being caused by the switching as greatly as possible. The amplitude and phase errors are known from the switching characteristics of the previous stage switch portions 8a and 8b and the subsequent stage switch portion 10A. By carrying out the digital signal processing through the DSP 10 in accordance with a known correction quantity, therefore, it is possible to carry out a correction in order to prevent the amplitude and phase errors from being caused by the switching. The amplitude correcting portion 10B and the phase correcting portion 10C serve to carry out the correction. The amplitude and phase errors caused by the switching are smaller than the amplitude and phase errors caused by the variation in the characteristic in the case in which two A/D converters are used and can be corrected more easily through the digital signal processing.

Although the description has been given to the example in which the amplitude and the phase of the digital Q signal are corrected, the present invention is not restricted thereto. For example, it is also possible to correct the amplitude and the phase of the digital I signal distributed by the subsequent stage switch portion 10A. Alternatively, it is also possible to correct the amplitude and the phase for both the digital I signal and the digital Q signal. Furthermore, it is also possible to correct the amplitude for the digital I signal and to correct the phase for the digital Q signal. As a matter of course, the correcting operations may be reversed.

Although the description has been given to the example in which the amplitude and the phase of the Q signal are corrected in accordance with the known quantity of the correction, the present invention is not restricted thereto. For example, it is also possible to detect an amplitude error between the digital I and Q signals distributed by the subsequent stage switch portion 10A, thereby setting the quantity of the correction of the amplitude correcting portion 10B so as to eliminate the amplitude error thus detected. Similarly, it is also possible to detect a phase error between the digital I and Q signals, thereby setting the quantity of the correction of the phase correcting portion 10C so as to eliminate the phase error thus detected. The amplitude and phase errors can be detected in accordance with the digital signal processing of the DSP 10.

The demodulating portion 10D carries out a demodulation processing by using the digital I signal supplied from the subsequent stage switch portion 10A and the digital Q signal supplied through the amplitude correcting portion 10B and the phase correcting portion 10C after the distribution through the subsequent stage switch portion 10A. The demodulating portion 10D has a function for removing an image component by a method of carrying out a complex frequency conversion, for example.

As described above in detail, in the first embodiment, the PPF 3 is provided in place of the conventional BPF in a previous stage of the mixer 4 and a harmonic component is removed by the PPF 3. By using the PPF 3, it is possible to enhance a quadrature property of an in-phase signal and a quadrature signal. Consequently, it is possible to prevent a phase error between the in-phase and quadrature signals from being caused by a variation in an analog element or the like.

In the first embodiment, the switch portions 8a and 8b for switching the I and Q signals and outputting them to the single A/D converter 9, and the I and Q signals output from the switch portions 8a and 8b are sequentially converted into digital signals through the A/D converter 9 and the digital signals thus obtained are supplied to the DSP 10. Consequently, the A/D conversion processing for the I and Q signals can be carried out by the same A/D converter 9. Therefore, it is possible to eliminate a drawback that the amplitude or phase error is made between the I and Q signals due to a variation in the A/D converting characteristic.

In the first embodiment, furthermore, the slight amplitude and phase errors made between the I and Q signals due to the switching in the previous stage switch portions 8a and 8b and the subsequent stage switch portion 10A are corrected by the DSP 10.

As described above, according to the first embodiment, it is possible to prevent the amplitude and phase errors from being made between the I and Q signals as greatly as possible, thereby suppressing an occurrence of the image component in the DSP 10 effectively. In the first embodiment, it is sufficient that the single A/D converter 9 is provided. Therefore, it is also possible to produce an advantage that an area of the circuit can be reduced.

### Second Embodiment

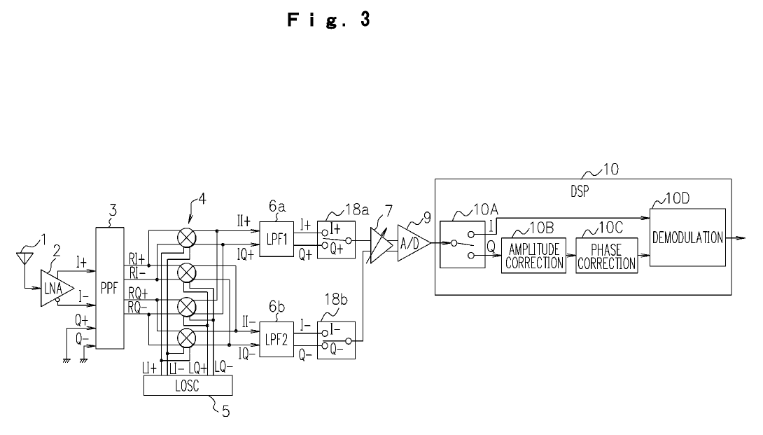

Next, a second embodiment according to the present invention will be described with reference to the drawings. FIG. 3 is a diagram showing an example of a structure of a receiver according to the second embodiment. Since components having the same reference numerals as those shown in FIG. 1 have the same functions in FIG. 3, repetitive description will be omitted.

As shown in FIG. 3, the receiver according to the second embodiment includes a receiving antenna 1, an LNA 2, a PPF 3, a mixer 4, a local oscillator 5, LPFs 6a and 6b, previous stage switch portions 18a and 18b, a VGA 7, an A/D converter 9 and a DSP 10. In FIG. 3, structures other than the receiving antenna 1 are integrated into a single chip through a CMOS process, for example.

The first previous stage switch portion 18a switches an in-phase signal I+ having a positive phase and a quadrature signal Q+ having a positive phase which are contained in an intermediate frequency signal having a positive phase that is output from the first LPF 6a, and outputs them to the VGA 7. The second previous stage switch portion 18b switches an in-phase signal I− having a negative phase and a quadrature signal Q− having a negative phase which are contained in an intermediate frequency signal having a negative phase that is output from the second LPF 6b, and outputs them to the VGA 7.

When the first previous stage switch portion 18a selects the in-phase signal I+ having the positive phase, the second previous stage switch portion 18b selects the in-phase signal I− having the negative phase. Consequently, the positive and negative in-phase signals (I signals) are input to the VGA 7. On the other hand, when the first previous stage switch portion 18a selects the quadrature signal Q+ having the positive phase, the second previous stage switch portion 18b selects the quadrature signal Q− having the negative phase. Consequently, the positive and negative quadrature signals (Q signals) are input to the VGA 7.

The VGA 7 corresponds to an “amplifier” according to the present invention and sequentially amplifies the I and Q signals output by alternate switching through the previous stage switch portions 18a and 18b. Then, the I and Q signals thus amplified are output to the A/D converter 9. In the second embodiment, a first signal processing system is constituted by the first LPF 6a and a second signal processing system is constituted by the second LPF 6b. The first LPFs 6a and 6b may be BPFs. Moreover, the VGA 7 may be omitted.

As described above in detail, in the second embodiment, the previous stage switch portions 18a and 18b are provided in a previous stage of the VGA 7 and the I and Q signals output from the LPFs 6a and 6b are switched and output to the single VGA 7. The I and Q signals amplified sequentially by the single VGA 7 are output to the single A/D converter 9 in order.

Consequently, the amplification processings for the I and Q signals can be carried out by the same VGA 7, and furthermore, the A/D conversion processings for the I and Q signals can be carried out by the same A/D converter 9. Therefore, a drawback that an amplitude error or a phase error is made between the I and Q signals due to a variation in an amplifying characteristic of the VGA or a converting characteristic of the A/D converter can be eliminated more effectively than that in the first embodiment.

As described above, according to the second embodiment, it is possible to prevent the amplitude or phase error from being made between the I and Q signals more effectively, thereby suppressing an occurrence of an image component in the DSP 10 more effectively. In the second embodiment, moreover, it is sufficient that the single VGA 7 and the single A/D converter 9 are provided. Therefore, it is also possible to produce an advantage that an area of the circuit can be reduced more greatly.

### Third Embodiment

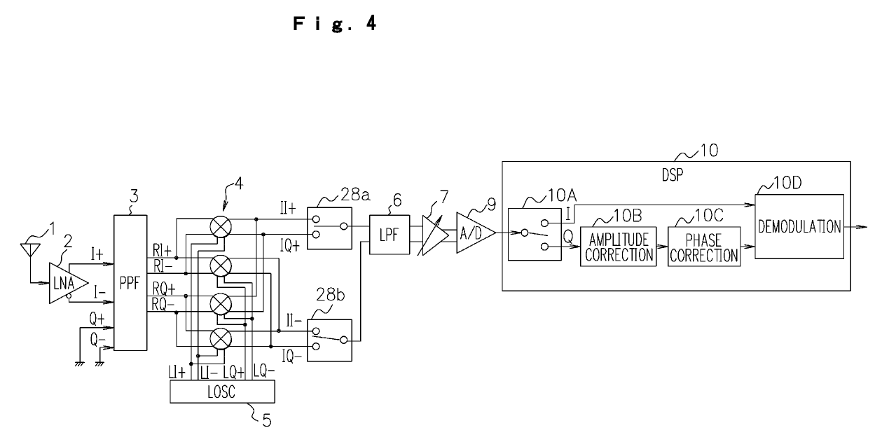

Next, a third embodiment according to the present invention will be described with reference to the drawings. FIG. 4 is a diagram showing an example of a structure of a receiver according to the third embodiment. Since components having the same reference numerals as those shown in FIG. 2 have the same functions in FIG. 4, repetitive description will be omitted.

As shown in FIG. 4, the receiver according to the third embodiment includes a receiving antenna 1, an LNA 2, a PPF 3, a mixer 4, a local oscillator 5, previous stage switch portions 28a and 28b, an LPF 6, a VGA 7, an A/D converter 9, and a DSP 10. In FIG. 4, structures other than the receiving antenna 1 are integrated into a single chip through a CMOS process, for example.

The first previous stage switch portion 28a switches an in-phase signal II+ having a positive phase and a quadrature signal IQ+ having a positive phase which are contained in an intermediate frequency signal having a positive phase that is output from the mixer 4, and outputs them to the LPF 6. The second previous stage switch portion 28b switches an in-phase signal II− having a negative phase and a quadrature signal IQ− having a negative phase which are contained in an intermediate frequency signal having a negative phase that is output from the mixer 4, and outputs them to the LPF 6.

When the first previous stage switch portion 28a selects the in-phase signal II+ having the positive phase, the second previous stage switch portion 28b selects the in-phase signal II− having the negative phase. Consequently, positive and negative in-phase signals (I signals) are input to the LPF 6. On the other hand, when the first previous stage switch portion 28a selects the quadrature signal IQ+ having the positive phase, the second previous stage switch portion 28b selects the quadrature signal IQ− having the negative phase. Consequently, positive and negative quadrature signals (Q signals) are input to the LPF 6.

The LPF 6 corresponds to a “filter portion” according to the present invention and sequentially carries out a band limitation to the I and Q signals switched alternately and output from the previous stage switch portions 28a and 28b, thereby removing harmonics. Then, the I and Q signals subjected to the band limitation are output to the VGA 7. The VGA 7 amplifies the I and Q signals output sequentially from the LPF 6 and outputs the I and Q signals thus amplified to the A/D converter 9. In the third embodiment, a first signal processing system and a second signal processing system are not distinguished from each other. The LPF 6 may be a BPF. Moreover, the VGA 7 may be omitted.

The previous stage switch portions 28a and 28b carry out switching in a cycle of 15.36 MHz. Therefore, the I and Q signals output from the previous stage switch portions 28a and 28b are subjected to sampling in a cycle of 15.36 MHz. In this case, when the LPF 6 is provided in a subsequent stage to the previous stage switch portions 28a and 28b, waveforms of the I and Q signals subjected to the sampling are distorted (dulled).

By providing a sample hold circuit (not shown) in an output stage of the previous stage switch portions 28a and 28b to hold, in the sample hold circuit, the waveforms of the I and Q signals subjected to the sampling through the previous stage switch portions 28a and 28b, therefore, it is possible to prevent the waveforms from being dulled. Alternatively, the sample hold circuit is not provided but a broadband filter may be used in place of the LPF 6.

As described above in detail, in the third embodiment, the previous stage switch portions 28a and 28b are provided in a previous stage of the LPF 6 and the I and Q signals output from the mixer 4 are switched and output to the single LPF 6. The I and Q signals subjected sequentially to the band limitation through the single LPF 6 are sequentially output to the single VGA 7 and the single A/D converter 9.

Consequently, amplification processings for the I and Q signals can be carried out by the same VGA 7 and A/D conversion processings for the I and Q signals can be carried out by the same A/D converter 9. In addition, the band limitations for the I and Q signals can be carried out by the same LPF 6. Therefore, a drawback that an amplitude error and a phase error are made between the I and Q signals due to a variation in a frequency characteristic of the LPF, an amplifying characteristic of the VGA or a converting characteristic of the A/D converter can be eliminated more effectively than that in the first and second embodiments.

As described above, according to the third embodiment, it is possible to more effectively prevent the amplitude error and the phase error from being made between the I and Q signals, thereby suppressing an occurrence of an image component in the DSP 10 more effectively. In the third embodiment, moreover, it is sufficient that the single LPF 6, the single VGA 7 and the single A/D converter 9 are provided. Therefore, it is also possible to produce an advantage that an area of the circuit can be reduced more greatly.

The first to third embodiments are only illustrative for a concreteness to carry out the present invention and the technical range of the present invention should not be construed to be restrictive. In other words, the present invention can be carried out in various forms without departing from the spirit or main features thereof.

### INDUSTRIAL APPLICABILITY

The present invention is useful for a receiver to distribute a radio frequency received signal into an in-phase component and a quadrature component to carry out a frequency conversion, thereby performing a quadrature demodulation by using an in-phase signal and a quadrature signal which are obtained.

This application is based on Japanese Patent Application No. 2008-044007 filed on Feb. 26, 2008, the contents of which are incorporated hereinto by reference.

What is claimed is:

1. A receiver comprising:
a polyphase filter for inputting a received radio frequency signal and outputting a four-phase radio frequency signal having phases shifted from each other by 90°;
a mixer for frequency-converting the four-phase radio frequency signal output from the polyphase filter with a local oscillating signal having a local frequency and generating a four-phase intermediate frequency signal from the four-phase radio frequency signal;
a switching portion for switching and outputting an in-phase signal having a positive phase and a quadrature signal having a positive phase which are contained in the intermediate frequency signals having positive phases among the four-phase intermediate frequency signals generated through the frequency-conversion in the mixer, and switching and outputting an in-phase signal having a negative phase and a quadrature signal having a negative phase which are contained in the intermediate frequency signals having negative phases among the four-phase intermediate frequency signals;
an A/D converter for converting, into digital signals, the in-phase and quadrature signals which are sequentially switched and output by the switching portion; and
a digital signal processing portion for carrying out a digital signal processing including a demodulation over the in-phase and quadrature signals output as the digital signals from the A/D converter,
wherein the digital signal processing portion includes an amplitude correcting portion for correcting an amplitude for at least one of the in-phase and quadrature signals output as the digital signals from the A/D converter, and
a phase correcting portion for correcting a phase for at least one of the in-phase and quadrature signals output as the digital signals from the A/D converter.

2. The receiver according to claim 1, wherein the switching portion includes a first switch for switching and outputting the in-phase signal having the positive phase and the quadrature signal having the positive phase which are contained in the intermediate frequency signals having the positive phase, and
a second switch for switching and outputting the in-phase signal having the negative phase and the quadrature signal having the negative phase which are contained in the intermediate frequency signals having the negative phase.

3. The receiver according to claim 2, wherein a first amplifier for amplifying the intermediate frequency signal having the positive phase is further provided in a previous stage of the first switch, and
a second amplifier for amplifying the intermediate frequency signal having the negative phase is further provided in a previous stage of the second switch.

4. The receiver according to claim 1, further comprising an amplifier for amplifying the in-phase and quadrature signals which are sequentially switched and output from the switching portion, the signals amplified by the amplifier being output to the A/D converter.

5. The receiver according to claim 1, further comprising a filter portion for carrying out a band limitation to the in-phase and quadrature signals which are sequentially switched and output from the switching portion, the signals subjected to the band limitation by the filter portion being output to the A/D converter.

6. The receiver according to claim 5, further comprising an amplifier for amplifying the signals subjected to the band limitation by the filter portion, the signals amplified by the amplifier being output to the A/D converter in place of the signals subjected to the band limitation by the filter portion.
